(19) United States
(12) Patent Application Publication
(10) Pub. No.: US 2025/0282447 A1
(43) Pub. Date: Sep. 11, 2025

(54) TRANSMISSION ASSEMBLY FOR A MOBILITY MACHINE

(71) Applicant: VALEO EMBRAYAGES, Amiens (FR)

(72) Inventors: Jonathan CAILLAUD, Saint Quentin Fallavier (FR); Jean Baptiste SIEGWART, Saint Quentin Fallavier (FR); Christophe LAURENS, Saint Quentin Fallavier (FR); Quentin DORET, Saint Quentin Fallavier (FR)

(73) Assignee: VALEO EMBRAYAGES, Amiens (FR)

(21) Appl. No.: 18/254,788

(22) PCT Filed: Nov. 26, 2021
(86) PCT No.: PCT/EP2021/083175

§ 371 Date: Feb. 28, 2024

(30) Foreign Application Priority Data
Nov. 27, 2020 (FR) FR2012232
Nov. 27, 2020 (FR) FR2012290
Nov. 27, 2020 (FR) FR2012295
Nov. 27, 2020 (FR) FR2012319
Nov. 27, 2020 (FR) FR2012338
Dec. 15, 2020 (FR) FR2013310
Dec. 15, 2020 (FR) FR2105137

(51) Int. Cl. B62M 11/06; B62M 6/45; B62M 6/55; B62M 9/06; F16H 57/02

(52) U.S. Cl. CPC B62M 11/06; B62M 6/45; B62M 6/55; F16H 57/02; B62M 9/06; F16H 2057/02034; F16H 2057/02043

(57) ABSTRACT

A drivetrain for a mobility vehicle includes: an electric motor and a gearshift device having a plurality of gear ratios between a first gear ratio and an upper gear ratio, the electric motor being connected to at least one output sprocket of the gear shift device.

The field of the present invention is that of so-called “sustainable” mobility, and more particularly that of mobility vehicles combining electric propulsion and muscular power, such as electrically-assisted bicycles.

The invention relates in particular to electrically-assisted city bikes as well as mountain or touring bikes and cargo bikes.

Environmentally-friendly modes of transport such as bicycles have long been popular in some countries, and continue to develop both for leisure and sporting activities, as well as for the needs of economic life and the transportation of goods and people. There is a need to improve the performance and reliability of these types of mobility vehicles, and to facilitate their manufacture and maintenance, whether electrically assisted or not.

When riding a bicycle, the rider provides the motive power, which is transmitted to the wheels via a crank system rotating about a pedal crank axle that drives the rear wheel, usually via a chain.

Gearboxes for bicycles are known in the prior art. In particular, FR2975367 A1 discloses a gearshift device for bicycles comprising a gearbox with gears and a sliding shuttle for gear ratio selection. The device and the gearbox gears are disposed in a common casing. Seals are provided at the junction of the various casing parts. There is a need to promote the circulation of air in the gears of a gearbox for a mobility vehicle, in particular devices with a pedal crank. There is also a need to prevent lubricating oil from leaking from the gears of cycle gearboxes, this in any position of use or rest.

As the field of light vehicles with a pedal crank for transporting goods or people diversifies, there is a need for automatic and electric gearboxes that are reliable and easy to manufacture.

Application DE102009029655 A1 describes a method for controlling the auxiliary electric drive of a bicycle. A control unit is provided to control the auxiliary electric drive in such a way that a uniform driving force is continuously generated from the power component applied by the rider and the power component applied by the auxiliary electric drive.

Application EP2480446 A1 discloses, for a bicycle having an auxiliary electric drive, a method Intended for recovering and storing energy when the direction of rotation of the pedal crank is directed backwards.

There is a need to promote and improve the control of electrically-assisted bicycles.

There is also a need to promote energy recovery when using electrically-assisted bicycles, particularly in braking mode.

One problem encountered with prior art devices, in particular known electrically-assisted bicycles, is shifting of gear ratio under load. This situation occurs in particular when the rider approaches a hill and feels the need to downshift because the effort becomes too intense or the pedaling frequency too low. The gearbox may find itself unable to change gear ratio due to the high torque flowing through it. There is a need to promote the shifting of gear of the gearboxes for mobility vehicles with a pedal crank.

In order to respond, at least in part, to these needs, the invention, according to a first aspect relates to a drivetrain for a mobility vehicle,

wherein said assembly comprises an electric motor, in particular disposed to provide a portion of the energy for the propulsion of the device, and a gearshift device comprising a plurality of gear ratios between a first gear ratio referred to as gear ratio no. 1 and an upper gear ratio, wherein the electric motor is connected to an output sprocket corresponding to one of the gear ratios of the gearshift device.

The mobility vehicle can be an electrically assisted mobility vehicle. In particular, the electric motor provides a portion of the propulsion power when the instantaneous speed of the mobility vehicle is below a threshold value.

In the context of this application, the terms “bicycle” and “bike,” as well as the expressions “mobility vehicle” and “device,” will be used interchangeably.

According to one embodiment, the device comprises at least one wheel, and may comprise two, three, four or even more wheels.

In the context of the present invention, the terms controller, rider and cyclist are equivalent. The device can be used with or without electrical assistance.

In one variant, the mobility vehicle has no electrical assistance.

The output sprocket of the gearshift device connected to the electric motor corresponds to one of the gear ratios of the gearshift device. According to various embodiments of the invention, the electric motor is connected to one or another of the output sprockets, without this choice being restrictive.

Advantageously, the drivetrain according to the invention has, alone or in combination, one or the other of the following features:
It comprises a reduction gear, wherein the electric motor is connected to the output sprocket of the gearshift device via the reduction gear, in particular, via a plurality of sprockets of the reduction gear. The plurality of sprockets can comprise five sprockets, in particular a first sprocket co-axial with the electric motor, a second sprocket which is input sprocket of the reduction gear, meshing with the first sprocket, a third sprocket which is the output sprocket of the reduction gear, connected in rotation with the second sprocket, wherein the third sprocket meshes with a fourth sprocket, a fifth sprocket disposed to mesh with the output sprocket of the gearshift device, wherein the fifth sprocket is integral with the fourth sprocket in rotation.
It comprises at least one freewheel. It may comprise one freewheel connected to the electric motor and/or one freewheel connected to the pedal crank.

In a particular example it comprises one freewheel connected to the electric motor, wherein the axis of the freewheel is, in particular, distinct from the axis of the electric motor. The freewheel connected to the electric motor is located, for example, in the fourth sprocket. This embodiment is particularly advantageous when the speed of the first sprocket and second primary multiplication sprockets is greater than or equal to a threshold value corresponding to the threshold speed of the mobility vehicle, above which the electric motor does not supply power. Thanks to the freewheel, the first sprocket and second primary multiplication sprockets are no longer connected to the electric motor and the user does not need to provide additional power to combat the inertia of the reduction gear and of the electric motor.
The drivetrain comprises a control unit disposed to control at least one of the electric motor and of the gearshift device. According to different implementation examples, the control unit is disposed to moreover control at least one of a braking system, a lighting system, a positioning and/or navigation system, a user-device interface system, this list not being exhaustive.
the drivetrain is accommodated in a casing, in particular, located at the level of the pedal crank
the gearshift device has between 2 and 12 gear ratios, or even between 5 and 9 gear ratios.
when the upper gear ratio is engaged, the output speed of the gearshift device is between 3 and 6 times higher, in particular 4.5 times higher, than the input speed of the gearshift device.
the jump in the reduction gear ratio between two consecutive gearshift device gear ratios is comprised between 10% and 50%, in particular between 15% and 40%, especially between 20% and 40%.
the gearshift device also features a neutral which, when engaged, does not allow movement of the pedal crank to propel the mobility vehicle.
The gearshift device comprises, in particular
   a series of input sprockets disposed to rotate freely about a selector shaft,
   a series of output sprockets, connected in rotation to a hollow shaft, wherein said hollow shaft is, in particular, disposed to surround a pedal crank axle of the mobility vehicle,
   a gearshift actuator disposed to engage a selected gear ratio.
      Each of the gear ratios presents a particular ratio between the output speed and the input speed of the gearshift device.

The gearshift actuator advantageously comprises electrical means for engaging a gear ratio, in particular a motor reduction gear. The control unit of the drivetrain is disposed, for example, to control the motor reduction gear of the gearshift actuator.

The gearshift actuator moreover comprises mechanical means for engaging a gear ratio, for example a longitudinally displaceable shuttle in the selector shaft 200 as described in the application FR2975367 A1.

According to another aspect, the subject matter of the invention is a casing suitable for accommodating a gearshift device for a mobility vehicle, wherein said casing comprises a first compartment to accommodate at least some of the gears of the gearshift device, wherein said casing comprises an air vent for venting of the first compartment.

According to this aspect, the invention maintains a venting of the gears of the gearshift device in all use or rest positions of the mobility vehicle. Oil leakage is prevented in all casing orientations. The most common orientations of the casing are:
horizontal orientation corresponding to use on level roads
two possible vertical orientations when the mobility vehicle is stored hanging by the wheel or by the rear wheel,
upside down, for example, when the cyclist transports their bike on a car roof or turns their bike upside down for repairs or maintenance
lying according to the inclination of the ground, for example, when the mobility vehicle is laid on the ground against a pedal

Advantageously, the casing according to the invention has, alone or in combination, one or the other of the following features:
the air vent is located in a cavity of the casing separate from the first compartment,
for any orientation of the casing, the volume inside the first compartment corresponding to the - - -lubricating oil volume of the gearshift device gears is located below the air vent,
said casing comprises at least one passage between the cavity and the first compartment, which, in particular, allows air to circulate. The passage is separate from the air vent. Advantageously, the casing comprises an upper passage and a lower passage.
it comprises at least a second compartment, to accommodate, in particular, an electric motor, a reduction gear, a gearshift actuator and/or a control unit of the mobility vehicle.
the cavity is separate from the second compartment(s). Advantageously, the cavity is centrally located. It is located in the casing between the first compartment and the second compartment(s).
   The cavity is positioned in such a way that in none of the orientations of the casing does the natural oil level of the first compartment reach the passage leading to the cavity. This prevents the filling of the cavity with oil. The passage(s) that allow air to circulate between the first compartment and the cavity can at times let oil through in certain orientations. Nonetheless, if oil remains temporarily trapped in the cavity, it will return to the first compartment as soon as the passageway is in a position allowing the cavity to drain under gravity.

The air vent is located in an area of the cavity that is distanced from any possibility of even a small reserve of oil. A suction of the oil is thereby prevented.

According to another of the aspects, the invention relates to an anti-theft method for a mobility vehicle, wherein said device comprises an electric motor disposed to provide all or a portion of the propulsion of said device and a gearshift device having a plurality of gear ratios between a first gear ratio called gear ratio no. 1 and an upper gear ratio, each of the gear ratios having its ratio, wherein said gearshift device further comprises a neutral which, when engaged, does not allow a movement of the pedal crank to propel the mobility vehicle and which comprises a gear change actuator disposed to engage a gear ratio selected from neutral and the various gear ratios between the gear ratio no. 1 and the upper gear ratio.

According to yet another aspect, the invention also relates to a control unit for a mobility vehicle,

wherein said device comprises an electric motor disposed to provide all or a portion of the propulsion of said device and a gearshift device has a plurality of gear ratios between a first gear ratio referred to as gear ratio no. 1 and an upper gear ratio,

wherein the control unit is disposed to control at least one of the electric motor and of the gearshift device.

Preferably the control unit is disposed to control the electric motor and the gearshift device.

The control unit is disposed to receive a command from a user of the mobility vehicle. The command is in particular a reverse command. It can be progressive in speed. In another example, the command is a regenerative braking command. According to still other implementation examples, the command is a command for activating the ‘pedestrian’ assistance mode, or for locking or respectively unlocking to activate or deactivate the anti-theft function.

In particular embodiments, the control unit is disposed to control at least one of a:
braking system
lighting system
positioning system
user-device interface system, wherein said user-device interface system is disposed to inform the user and/or consider requests of said user. The user-device interface system is, in particular, disposed to transmit a signal to the control unit as previously described, the signal corresponding to an instruction for a change of the gear ratio. The user-device interface system is suitable to present the user with information received from the control unit.

Advantageously, the control unit may comprise or be connected to at least one device for determining the position of the pedal crank. The device for determining the position of the pedal crank is, for example, a system for measuring said position by means of a sensor.

In one variant, the control unit comprises such a device for determining the position of the pedal crank and estimates the position of the pedal crank by calculation.

The control unit can comprise or be connected to at least one sensor selected from a sensor for measuring the instantaneous speed of the mobility vehicle, an accelerometer, a gradient sensor, a pedaling cadence sensor, a cyclist torque sensor and a sensor for measuring the attitude of the mobility vehicle.

In the present application, the terms “pedaling cadence,” “pedaling frequency” and “pedaling speed” are used equivalently.

In the context of the present application, the term “pedal crank” referring, for example, to an electrically-assisted bicycle is to be understood in a broad sense used to describe any torque input means provided by a user of the mobility vehicle.

The control unit is, in particular, disposed to implement a method as described in the present application.

According to yet another aspect, the invention relates to an anti-theft system for a mobility vehicle comprising
a gearshift device having
   a. a plurality of k gear ratios between a first gear ratio referred to as gear ratio no. 1 and an upper gear ratio, wherein each of the gear ratios has a particular reduction gear ratio, between an input shaft, disposed to be connected to a pedal crank of the mobility vehicle, and an output shaft of the gearshift device, when the corresponding gear ratio is engaged,
   b. a neutral which, when engaged does not allow a movement of the pedal crank to propel the mobility vehicle,
a control unit disposed to control the gearshift device.

The anti-theft system according to the invention can comprise or be connected to a control, for example a button or a set of keys on the user interface.

According to yet another of these aspects, the invention also relates to a mobility vehicle comprising a gearshift device and/or a drivetrain as described above, and/or a control unit as described above and/or a casing.
The mobility vehicle comprises, for example, at least one sensor selected from:
   a sensor for determining the position of the pedal crank,
   a sensor for determining the speed of rotation of the pedal crank,
   a speed sensor of the mobility vehicle,
   an accelerometer for measuring an acceleration of the mobility vehicle,
   a slope sensor to measure a slope of the travelling area,
   a torque sensor to measure a torque generated by the user.
The control unit is, for example, disposed to receive commands from the user and/or data from a sensor and/or the positioning/navigation system. A command of the user is, in particular, a command for reverse travel. It can be progressive in speed. In another example, the command is a command for regenerative braking.

According to another of its aspects, the invention relates to a mobility vehicle comprising a gearshift device accommodated in a casing as described above.

The device may comprise a battery or any other rechargeable means for powering the electric motor and/or the actuator of the gearshift device.

The device comprises, in particular, a battery or any other rechargeable means known to the person skilled in the art for supplying the energy required to power the electric motor, a lighting system, a pedal crank, a positioning and/or navigation system as well as a user-device interface system.

According to another aspect, the invention relates to a method for controlling a mobility vehicle, wherein said device comprises an electric motor disposed to provide all or a portion of the propulsion of said device and wherein a gearshift device has a plurality of gear ratios between a first gear ratio referred to as gear ratio no. 1 and an upper gear ratio, each of the gear ratios having one ratio, wherein said gearshift device comprises a gearshift actuator disposed to engage a selected gear ratio having one ratio, wherein said method allows, in particular, to control at least one of the electric motor and of the gearshift device.

The mobility vehicle can be an electrically assisted mobility vehicle for which the electric motor provides, in particular, a portion of the propulsion power when the instantaneous speed of the mobility vehicle is below a threshold value.

According to this aspect, the invention thus enables control of the gearshift device of a mobility vehicle, in particular an electric bicycle. The change in gear ratio of the gearshift device is smooth and does not require activation by the user.

More specifically, the control of the electric assistance motor according to the invention facilitates changes of the gear ratio of the same gearshift device.

This method for controlling according to the invention makes it possible to integrate an electric assistance motor and an automatic and adaptive gearshift device into the pedal crank. Thanks to the invention, the bike therefore adapts to the rider and no longer the other way around. With the invention, the shifting of gears is automatic and the method according to the invention instantly adjusts the intensity of electric assistance required by the cyclist, this both while travelling as well as at the first pedal stroke. In automatic mode, the control unit determines the optimum assistance level and gear ratio. The user maintains the possibility at all times to switch to manual mode, and, in particular, to select a particular gear ratio. Advantageously, the electric motor is located downstream of the gearshift device in the torque transmission chain, for example, connected to the output shaft of the gearshift device.
Unless otherwise specified, the electric motor is disposed to rotate in a direction corresponding to forward travel of the mobility vehicle. In some implementations of the invention, the electric motor rotates in an opposite direction, corresponding to the mobility vehicle traveling in reverse.
As the electric motor is located downstream of the gearshift device, it can generate drive torque without needing to pass through the gearshift device. The gearshift actuator can then act without any additional clamping force on the part of the electric motor.
The control of an instantaneous and high torque of the electric motor allows for an acceleration of the transmission chain downstream of the gearshift device, which brings about a release of the tension between the input and output of this same device. As a result, the gearshift actuator is subjected to a reduced clamping force.

Advantageously, the method for controlling according to the invention presents, alone or in combination, at least one or other of the following steps concerning the controlling of the gearshift device or the controlling of the electric motor:
A step of increasing the torque of the electric motor, in particular, in response to a signal corresponding to a request to change the gear ratio. The signal corresponds, for example, to an instruction from a user of the mobility vehicle to change the gear ratio. In one variant, the signal results from a step of calculation of the optimum gear ratio, as described below. This step of increasing the torque of the electric motor (also called “boost” step) can be triggered automatically by a method according to the invention. This automatic triggering occurs, in particular, when the control unit determines that the change of the gear ratio to be made requires additional assistance, which is to say, a spike in motor power for a set time in order to provide additional assistance to the rider without the rider feeling a jolt.
In the case of an electrically-assisted device, the application of instantaneous and high motor torque at the moment when the cyclist generates the least force enables optimum relief of strain in the gearshift device when the gearshift actuator makes a shift. A position sensor or estimator (via a measured cyclist torque or speed profile) can, moreover, be used to define an optimum instantaneous gear ratio, as a function of time.
In a variant of this step, the implementation thereof comes about following a command, for example, via a handlebar controller, from the user who wishes to benefit from a momentary increase in the torque of the electric motor, for example to facilitate overtaking or climbing a hill. Such a command, in particular, triggers a power boost step for a pre-programmed duration, for example, 10 seconds. In one variant, the continued holding of a control, such as a button or ratchet, at the user interface determines the actual duration of the step as long as it remains shorter than a maximum duration.
A step of reduction of the electric motor torque. Prior to the step described above, it may be advantageous to reduce the motor torque before increasing in an important way.
A step of engaging a selected gear ratio of the gearshift device, in particular preceded by a step of selecting said gear ratio. During this step, the control unit controls the gearshift actuator on the basis of a command of the user to indicate the selected gear ratio. In a preferred variant, the command is the result of a calculation performed by the control unit.
A step for calculation of the optimum gear ratio of the gearshift device
A step of engaging neutral for which the output of the gearshift device is not connected to the pedal crank. Such a neutral can be engaged, for example, following a command of the user. The latter user may, for example, decide to activate a ‘pedestrian’ assistance mode when they decide to push the bike. This function is particularly useful when carrying a load.
A regenerative braking step. The gearshift device is, in particular, in neutral. The movement of the wheel turns the electric motor, which acts as a generator and charges the battery when the battery is partially discharged. In one variant, the regenerative braking step is followed by a mechanical braking step in which the control unit controls the braking system.
A step of control of the electric motor in reverse, which is to say, in a direction corresponding to a movement of the mobility vehicle in reverse. The gearshift device is, in particular, in neutral. In a particular implementation, the user can move alongside the reversing device.
A step of clamping of at least one wheel of the device, either the front wheel or the rear wheel. This step provides a particularly easy-to-implement anti-theft solution for the mobility vehicle.
A low battery management step. For example, when the battery reaches low state of charge, the control unit that supports the method according to the invention switches to the second gear ratio of the gearshift device.

In an advantageous embodiment, the method according to the invention is adaptive. According to this particular embodiment, the method according to the invention gathers the needs of the user, not only in the form of command of the users, but also through an analysis of driving style and route constraints.

The shifting of gear ratios of the gearshift device is smooth. The user can, in particular, choose a fully automatic mode of controlling the gearshift system, requiring no further activation on their part.

According to yet another of its aspects, the invention relates to a regenerative braking method for a mobility vehicle implemented with the aid of a drivetrain, as described above.
The regenerative braking method comprises, in particular, a motor braking step which may be preceded by a step of engaging neutral. Motor braking means that the motor no longer drives the wheels in this step. It is the wheels that drive the motor and recharge the battery or rechargeable power supply of the electric motor.
Advantageously, the motor braking step is followed by a mechanical braking step, during which a mechanical brake system is activated.
During the motor braking step, the motor speed is in the opposite direction to the torque.

According to yet another of its aspects, the invention relates to a reversing method for a mobility vehicle implemented using a drivetrain, as described above.
The reversing method comprises, in particular, a step of controlling the electric motor in reverse, which is to say, in a direction corresponding to a movement of the mobility vehicle in reverse, in particular preceded by a step of engaging neutral.

According to yet another aspect, the invention relates to an anti-theft device for a mobility vehicle, wherein said device comprises an electric motor disposed to provide all or a portion of the propulsion of said device and wherein a gearshift device has a plurality of gear ratios between a first gear ratio called gear ratio no. 1 and an upper gear ratio, each of the gear ratios having a ratio, wherein said gearshift device further has a neutral which, when engaged, does not allow movement of the pedal crank to propel the mobility vehicle and comprises a gear change actuator disposed to engage a gear ratio selected from neutral and the various gear ratios between the gear ratio no. 1 and the upper gear ratio.

### EXAMPLES OF PARTICULAR SITUATIONS

In the examples described, the electric motor is a 48V brushless electric motor. The invention is not limited to this choice of motor.
With a torque of 133 Nm (Newton-meter), the motor used in the following examples can increase the force of the rider by a factor of eight or even nine.

### Example 1: Hill start—Slope Sensor Embodiment

In one variant, the control unit comprises an accelerometer or is disposed to receive a signal from an accelerometer or a slope sensor. The slope sensor is, for example, integrated into the casing of the electric motor. The control unit thus receives real-time information relating to the slope on which the mobility vehicle is located and/or is moving.
On an uphill slope, the rider will need to provide a strong torque to move the bike.
When starting off, the slope sensor provides the control unit with information relating to the slope on which the bike is located.
Knowing the maximum torque that the gearshift device can withstand during a change in gear ratio, the control unit commands the gearshift device actuator to position the gearshift device in a gear ratio referred to as optimal gear ratio corresponding to an optimization of the pairing of user torque-pedaling frequency to be provided by the cyclist even before they have started pedaling.

### Example 2: Detection and Anticipation of the Slope by a Positioning and/or Navigation System During Travel

In this example, the control unit comprises or is connected to a satellite positioning sensor and, optionally, to a sensor provided to characterize the pedaling of the cyclist, such as a pedaling frequency sensor. The satellite positioning sensor is located, for example, in the casing likewise accommodating the drivetrain. Alternatively, the satellite positioning sensor is located on the frame of the mobility vehicle. The control unit, on the basis of the information received from the positioning sensor, as well as anticipation of the route and altitude variations of the cyclist over the upcoming meters, calculates whether the anticipated pedaling torque is greater than that which the gearshift device can withstand when changing gear ratio.
In particular, the method determines the gear ratio of the gearshift device, which is to say, the optimum gear ratio that corresponds to the optimal pairing of user torque-pedaling frequency to be provided by the cyclist.

### Example 3: Load Transport When Exiting a Parking Lot (14% Slope)

In this example, the mobility vehicle is a cargo bike with a load of 150 kg.
The electric motor used in the invention permits to provide extra power for a limited period of time, making it easier to maneuver the mobility vehicle in extreme situations. Because of their steep gradients, parking lot slopes are particularly difficult urban environments. The invention facilitates the use of the cargo bike, both forwards and backwards. When going uphill, the method according to the invention automatically provides extra power, enabling the rider to climb a 14% gradient effortlessly.
When going downhill, the method activates, in particular, the regenerative braking function to recharge the battery.

### BRIEF DESCRIPTION OF THE FIGURES

Other features, details and advantages of the invention will become clearer upon reading of the description given here below by way of example in relation to the drawings provided, wherein:

FIG. 1 is a view of a mobility vehicle according to one aspect of the invention,

FIG. 2 illustrates the drivetrain of the mobility vehicle of FIG. 1,

FIG. 3 illustrates a cross-section of the torque path for a particular embodiment of the invention,

FIG. 3a and FIG. 3b illustrate details of variants of the embodiment of FIG. 3,

FIG. 4 illustrates a casing accommodating a drivetrain according to the invention,

FIG. 5a through FIG. 5d schematically illustrate the casing of FIG. 4 in different orientations,

FIG. 6 is a schematic view of an implementation of a method of controlling according to one aspect of the invention,

FIG. 7a and FIG. 7b illustrate a particular implementation of the invention, and

FIG. 8a and FIG. 8b illustrate a further implementation of the invention,

FIG. 9 illustrates in block diagram form the various steps of an anti-theft method according to the invention,

FIG. 10 presents a curve showing the relationship between the threshold force needed to be provided by the cyclist and the level of assistance that is instantly available, and

FIG. 11 graphically illustrates several examples of the implementation of the invention

### DETAILED DESCRIPTION OF THE INVENTION

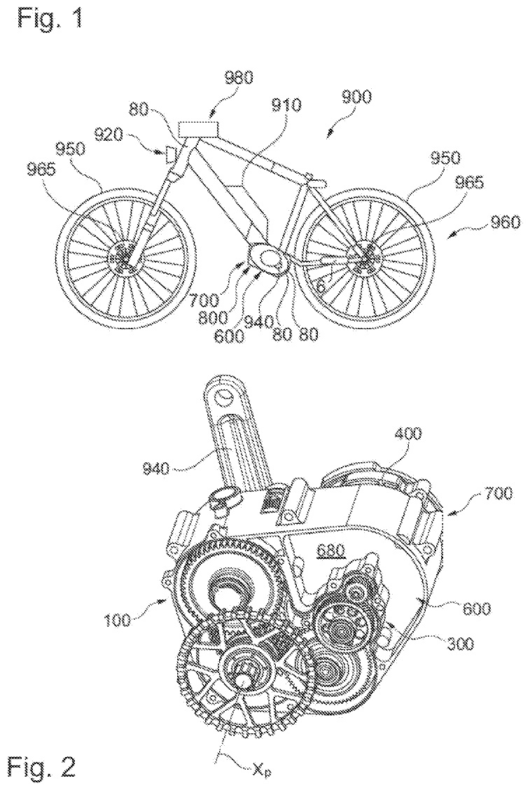

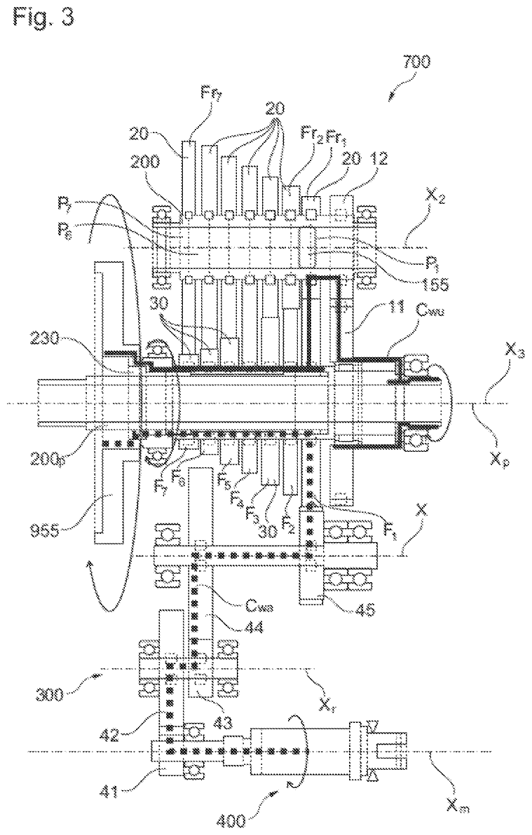

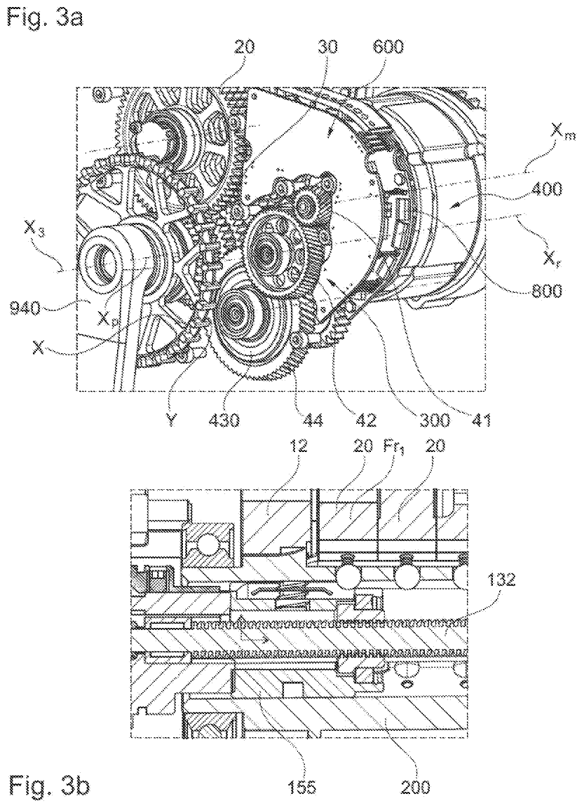

FIG. 1 illustrates a mobility vehicle 900 according to one aspect of the invention. The device 900 here is an electrically assisted bicycle comprising an electric motor 400 having an axis of rotation Xm. Said electric motor is disposed to provide a portion of the propulsion of said device.
When moving without electric assistance, the motive force is provided by the cyclist, and is transmitted to the wheels 950 via two pedals rotating about a pedal crank axle which drives the rear wheel via a chain. The torque path for use with and without electric assistance is described in greater detail below, with reference to FIG. 3.
As shown in FIG. 1, the device 900 comprises a control unit 800 as well as a plurality of sensors 80, located, in particular, at the pedal crank, on the bicycle frame or at one wheel. The control unit 800 is, in particular, disposed to control the electric motor 400 and the gearshift device 100.
The device 900 shown here also comprises an energy storage device in the form of a battery 910, a lighting system 920, a pedal crank 940 having an axis Xp, a positioning and/or navigation system 980 and a user-device interface system 990 comprising, in particular, a touch screen suitable to display information for said user and/or taking into account requests of said user. The user-device interface system 990 is in particular connected to the positioning system 980 and serves as a navigation interface. The invention is not limited to a particular user-device interface system, and may include any system known to the person skilled in the art.

The wheels 950 are equipped with a braking system 960, comprising, in particular, disc brakes 965.

The device 900 comprises a drivetrain 700 shown in FIG. 2. The drivetrain 700 comprises a gearshift device 100 and an electric motor 400 with an axis of rotation Xm to provide a portion of the power for propulsion of the device.

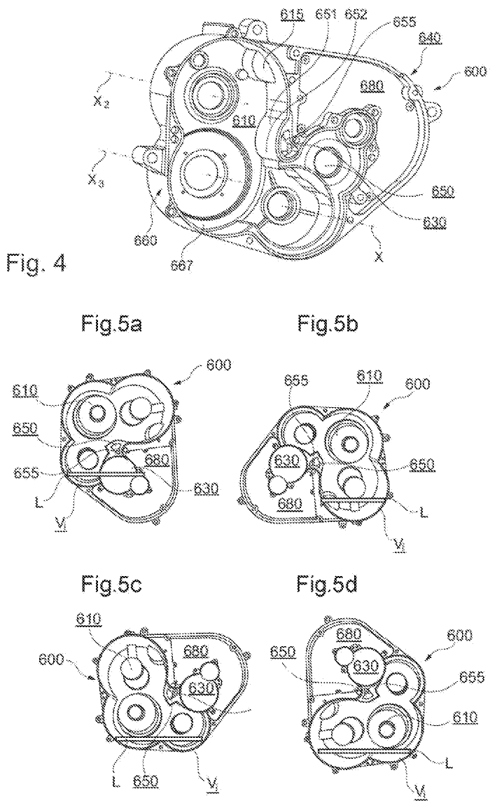

As shown in FIG. 1 and FIG. 2, the gearshift device 100 is accommodated in a casing 600 illustrated in more detail in FIG. 4. The casing 600 is positioned here at the pedal crank 940, the axle of which is coincident with the output axis Xs of the gearshift device 100.

The gearshift device 100 has a plurality of k gear ratios between a first gear ratio referred to as gear ratio no. 1 and an upper gear ratio referred to as gear ratio No. k.

As shown in FIG. 3, the gearshift device 100 as illustrated comprises
a series of input sprockets 20 disposed to rotate freely about a selector shaft 200,
a series of output sprockets 30, connected in rotation to a hollow shaft 230, wherein said hollow shaft is disposed to surround a pedal crank axle 200p of the mobility vehicle 900,
a gearshift actuator disposed to engage a selected gear ratio.
   The gearshift actuator comprises mechanical means for engaging a gear ratio, for example, here a longitudinally displaceable shuttle 155 in the selector shaft 200 which is hollow, and electrical means for engaging a gear ratio, in particular, a motor reduction gear for displacing the shuttle 155 between a position P₀ corresponding to neutral and positions P₁ to P₇ corresponding to the gear ratios no. 1 to no. 7.

FIG. 3 shows the torque path Cwu in solid lines for the torque supplied by the user, in particular, without electric assistance. The torque input is via a shaft 200p of the pedal crank 940, the torque passes through a first primary multiplying sprocket 11 which meshes with a second primary multiplying sprocket 12. The first primary multiplying sprocket 11 is connected in rotation to shaft 200p of the pedal crank and the second primary multiplying sprocket 12 is connected in rotation to a primary shaft 200. There is a permanent reduction gear ratio between shaft 200p of the pedal crank and the primary shaft 200
The primary shaft 200 supports a series of input sprockets 20 disposed to mesh with a series of output sprockets 30. The number of input sprockets 20 and output sprockets 30 corresponds to the number of gear ratios of the gearshift device, here equal to 7.
In the example, the input sprockets 20 are referenced Fri from Fr1 to Fr7 and output sprockets 30 Fi from F1 to F7 depending on the gear ratio i selected. The input sprockets 20 are free and the output sprockets 30 are fixed in relation to the output shaft 230. All output sprockets 30 are thus linked to chain sprocket 955 by the output shaft 230.

In the context of this application, the terms “free” and “fixed” are respectively understood to mean “free to rotate in relation to its axis” and “fixed in rotation in relation to its axis”.

The first primary multiplication sprocket 11, the second primary multiplication sprocket 12, the input sprockets Fr1 to Fr7 and the output sprockets F1 to F7 form the gears of the gearshift device 100.
The torque passes through the free sprocket Fri, which meshes with the output sprocket Fi corresponding to the selected gear ratio i. In the example shown in FIG. 3, gear ratio no. 1 is selected: the free sprocket Fri meshes with output sprocket F1. Gear ratio no. 1 here corresponds to a ratio of 1, without this value being limiting of the invention.
Lastly, the torque is transmitted to the wheel 950 by the ring gear 955 connected by a chain or belt.
Similarly, the torque path Cwa of the electric assistance is shown as a dashed line. The torque coming from the user is the same as before. However, this time it is combined with the torque from the electric motor 400.
In the illustrated example, the electric motor 400 is connected to output sprocket F1 corresponding to a gear ratio no. 1 of the gearshift device 100.
The electric motor 400 is connected to the output sprocket F1 via a plurality of sprockets 40 of a reduction gear 400. In the example shown, the plurality of sprockets 40 is formed by five sprockets:
   a first sprocket 41 co-axial to the electric motor 400,
a second sprocket 42 meshing with the first sprocket, wherein the second sprocket 42 is an input sprocket of the reduction gear 300,
a third sprocket 43, an output sprocket of the reduction gear 400, connected in rotation with the second sprocket 42, wherein the third sprocket 43 meshes with
a fourth sprocket 44, and
   a fifth sprocket 45 meshing with said third sprocket 43, wherein the fifth sprocket 45 is connected in rotation with the fourth sprocket.

The gearshift actuator 150 comprises mechanical means for engaging a gear ratio, in this case a longitudinally displaceable shuttle 155 in the selector shaft 200 that is hollow, and electrical means for engaging a gear ratio, in particular, a motor reduction gear for displacing the shuttle 155 between positions Px corresponding to the different speed gear ratios.

In the variant of the invention illustrated in FIG. 3a, the drivetrain 700 comprises a freewheel 430, having an axis Y, wherein said freewheel is connected to the electric motor 400. The axis Y is here distinct from the axis Xm of the electric motor. The freewheel connected to the electric motor is located in the fourth sprocket 44 with axis X, which coincides with the axis Y. Thanks to the freewheel, when the user drives the device 900 beyond the threshold speed at which the electric motor 400 no longer provides power, the first primary multiplier sprocket 11 and the second primary multiplier sprocket 12 are no longer connected to the electric motor 400. This eliminates the need for the user to provide additional power to combat the inertia of the reduction gear 300 and electric motor 400,

In a variant of the invention, a neutral or gear ratio 0 of the gearshift device 100 can be engaged. This configuration is illustrated in FIG. 3b. Shuttle 155 is in a position PO corresponding to neutral. No free sprocket Fri engages an output sprocket and the movement of the pedal crank 940 does not allow the wheel 950 to be driven.

FIG. 4 illustrates in greater detail the casing 600 of the mobility vehicle 900 of FIG. 1.
The casing 600 comprises a crankcase 660 delimiting a first compartment 610 and a plurality of second compartments, each distinct from the others. The first compartment 610 is disposed to accommodate the gears of the gearshift device 100. The second compartments 640, 630, 615, and 680 are disposed to respectively accommodate the electric motor 400, respectively the reduction gear 300, the gearshift actuator 150 and the control unit 800 of the mobility vehicle. The second compartments are preferably sealed, in particular the one disposed to contain the control unit 800.
The crankcase 660 accommodating the gearshift device 100 is closed by two side flanges 667. The casing 600 is shown empty and with only one flange 667 in FIG. 4 and FIG. 5a through FIG. 5d, in order to make the various first and second compartments more visible. The first compartment 610 has two holes facing each other in the side flanges 667 to accommodate the pedal crank axle of the mobility vehicle 900.
FIG. 5a and FIG. 5d show an orientation of casing 600 corresponding to a bicycle, like the mobility vehicle 900 of FIG. 1, suspended by the front wheel 950, respectively by the rear wheel 950. The orientation of the casing 600 in FIG. 5c corresponds to travel on a level road. The orientation of the casing 600 in FIG. 5b corresponds to a bike on the ground on its pedal, the wheels being raised in relation to pedal crank 940. Level L corresponds to the surface area of volume Vi which is filled with lubricating oil for the gears of gearshift device 100 in different positions of the mobility vehicle, corresponding to different orientations of casing 600. The oil then gravitates into volume Vi in a lower part of the first compartment 610. The oil volume Vi is in particular between 50 ml and 60 ml.
As illustrated for these orientations of the casing, and for any other orientation of the casing 600, the volume Vi is located below the air vent 655. Volume Vi is likewise located below the upper passage 651 and the lower passage 652, thus preventing a leakage of oil between the first compartment 610 and the cavity 650.
The embodiments described above relate to an electrically assisted bicycle, the invention is not limited to one type of mobility vehicle.

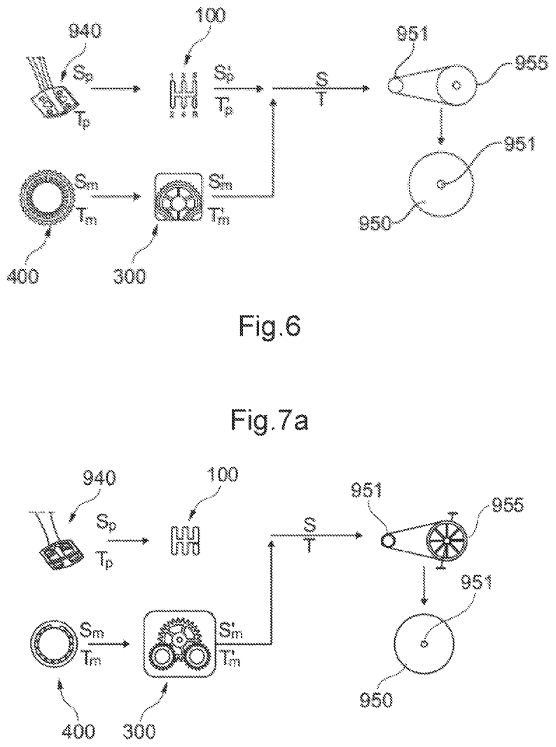

FIG. 6 schematically illustrates a control method P according to the invention.
When driving the mobility vehicle 900 in travel mode, the driver pedals at a pedaling speed Sp corresponding to an input torque Tp of the gearshift device 100. As a function of the engaged gear ratio Gi having a ratio rᵢ, the output speed S′p of the gearshift device 100 is equal to the pedaling speed divided by the ratio rᵢ:S′p=Sp/rᵢ,
The electric motor 400 rotates at a speed Sm. It is associated with a reduction gear 300 having a gear ratio Ra, or ratio Ra. The reduction gear output speed S′m=Sm/Ra,
the torque supplied is equal to the motor torque multiplied by the gear ratio of the reduction gear 300: T′m=Tm×Ra.

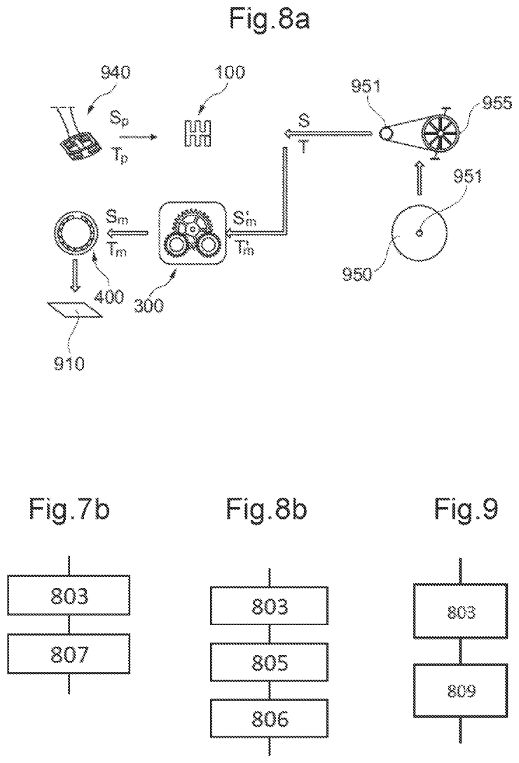

FIG. 7a schematically illustrates a control method P according to the invention when implementing reverse gear. The gearshift device 100 is in neutral. The pedal crank is not connected to the electric motor 400 or to the output of the gearshift device 100. The user does not provide any useful torque even if they pedal at a pedaling speed Sp corresponding to an input torque Tp of the gearshift device 100.
The useful torque then comes solely from the electric motor 400. Even if the user U pedals, the torque produced by the movement of the pedal crank 940 will not be transmitted to the wheel. The electric motor 400 turns in the opposite direction, driving the wheel in reverse. Speed and torque are negative here.
The electric motor 400 rotates at a speed Sm. It is associated with a reduction gear 300 having a gear ratio Ra. The reduction gear output speed S′m=Sm/Ra,
the torque supplied is equal to the motor torque multiplied by the gear ratio of the reduction gear 300: T′m=Tm×Ra.

FIG. 7b shows a block diagram of the method steps following a command of the user to reverse. In a step 803, the control unit 800 preliminarily commands the gearshift device 100 to switch to neutral. The control unit commands the gearshift device actuator 150 so that no free sprocket 20 of the gearshift device is engaged.
Once the gearshift device 100 is in neutral, the control unit 800 commands the electric motor 400 in step 807 to propel the mobility vehicle 900 in reverse. The useful torque then comes solely from the electric motor 400. Even if the user U pedals, the torque produced by the movement of the pedal crank 940 will not be transmitted to the wheel. The electric motor 400 rotates in the opposite direction, driving the wheel in reverse. In one embodiment, the drivetrain features a potentiometer connected to the control sensor of reverse travel. The user U can thus select the speed of the electric motor 400 in a continuous manner up to a maximum reverse speed value. In one variant, depending on the command of the user U, the motor speed in reverse can take one or a plurality of discrete values.

FIG. 7a corresponds to FIG. 6 when reverse gear is implemented. The gearshift device 100 in neutral is not connected to the electric motor 400, and the user does not provide any useful torque.

FIG. 8a schematically illustrates a control method P according to the invention when implementing regenerative braking. The gearshift device 100 is in neutral. The torque path diagram is reversed during the motor braking step. The movement of the wheel 950 rotates the electric motor 400, which acts as a generator and can charge the battery 910 to full charge. Speed and torque are here in opposite directions. Regenerative braking can, in particular, be implemented in forward travel gear, which is to say, with positive speed and negative motor torque, or in reverse travel gear, which is to say, with negative speed and positive motor torque.

FIG. 8b illustrates the method steps following a braking command from user U. In a step 803, the control unit 800 preliminarily commands the gearshift device 100 to switch to neutral. The control unit commands the gearshift device actuator 150 so that no free sprocket 20 of the gearshift device is engaged. Once the gearshift device 100 is in neutral, the control unit 800 commands the electric motor 400 in a motor braking step 805.

As illustrated in FIG. 8a, the gearshift device 100 in neutral is not connected to the electric motor 400, and the torque path pattern is reversed in the motor braking step 805. The movement of the wheel 950 turns the electric motor 400, which acts as a generator and can charge the battery 910 until it is fully charged. If battery 910 is fully charged, or in the event of a prolonged braking command, the motor braking step 805 is followed by a mechanical braking step 806 in which the control unit commands the braking system 960.

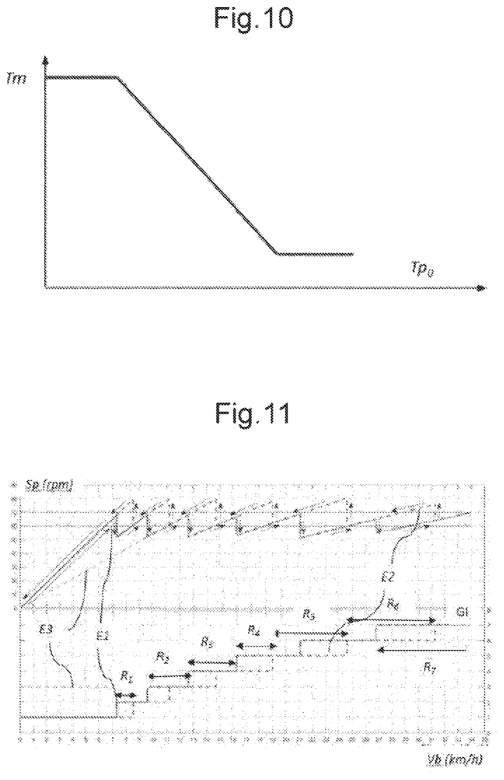

FIG. 9 illustrates the method steps following a lock command to activate the anti-theft function of the mobility vehicle. In a step 803, the control unit 800 commands the gearshift device 100 to switch to neutral. The control unit commands the gearshift device actuator 150 so that no free sprocket 20 of the gearshift device is engaged.
Once the gearshift device 100 is in neutral, the control unit 800 commands a step 809 for the clamping of at least one of the wheels of the device.
The method according to the invention continuously adjusts the force threshold Tp₀ to be provided by the cyclist to the instantaneously available assistance level Tm according to a law illustrated in FIG. 10.

If, as a function of the travel parameters reported by the sensors when using the device 900 the rider is found to be in the zone below the curve shown, the force threshold Tp₀ is adjusted in real time to the available assistance level Tm so as to position the rider on the curve.

The curves showing the speed Sp of the pedal crank 940 as a function of the engaged gear ratio

Gi shown in FIG. 11 correspond to three implementations of a method according to the invention. These examples relate, in particular, to the device 900 illustrated above, the gearshift device of which has seven gear ratios. The method P defines, in particular adaptively defines, a speed range Ri going from R₁ to R₇ for the mobility vehicle for each gear ratio Gi
Curve E1, depicted with solid lines, corresponds to a first implementation example with a pedaling speed range Sp around 60 rpm, for example between 50 rpm and 70 rpm, wherein it is advantageous to increase the gear ratio.
Curve E2, depicted with dashed lines, corresponds to a second implementation example with a pedaling speed range Sp around 70 rpm, for example between 60 rpm and 80 rpm, wherein, in particular, a decrease in the gear ratio is favorable.
Curve E3 corresponds to a third example of implementation with a speed range Sp around 60 rpm and an immediate start-up in gear ratio 3.
Inasmuch as the shift in gear ratio always takes place over an interval, the control unit analyzes, once the cyclist has a stabilized gear ratio, whether the rider is naturally
   centered in the interval: in which case the shifting law followed by the cyclist is perfectly adapted
   shifted towards the upper limit of the interval: in which case the method proposes an higher speed interval
   shifted towards the lower limit of the Interval: in which case the method proposes a lower speed interval

The method according to the invention takes, in particular, travel conditions into account. In particular, in the case of uphill stretches in the travel zone, pedaling speed is increased to reduce muscular force.

1-15. (canceled)

16. A drivetrain for a mobility vehicle, comprising:
an electric motor and a gearshift device having a plurality of gear ratios between a first gear ratio referred to as gear ratio no. 1 and an upper gear ratio,
wherein the electric motor is connected to at least one output sprocket of the gearshift device.

17. The drivetrain according to claim 16, further comprising a reduction gear,
wherein the electric motor is connected to said output sprocket of the gearshift device via the reduction gear.

18. The drivetrain according to claim 16, further comprising a freewheel connected to the electric motor.

19. The drivetrain according to claim 18, wherein an axis of the freewheel is distinct from a motor axis.

20. The drivetrain according to claim 19, wherein the freewheel is located in a fourth sprocket.

21. The drivetrain according to claim 16, wherein the gearshift device has between 2 and 12 gear ratios.

22. The drivetrain according to claim 16, wherein the gearshift device further has a neutral which, when engaged does not allow the movement of a pedal crank to propel the mobility vehicle.

23. The drivetrain according to claim 16, wherein when the upper gear ratio is engaged, the output speed of the gearshift device is between 3 and 6 times higher than the input speed of the gearshift device.

24. The drivetrain according to claim 16, wherein the reduction gear ratio jump between two consecutive gear ratios of the gearshift device is comprised between 10% and 50%

25. A control unit for a mobility vehicle comprising a device comprising an electric motor disposed to provide at least a portion of propulsion of said device and a gearshift device having a plurality of k gear ratios between a first gear ratio referred to as gear ratio no. 1 and an upper gear ratio referred to as gear ratio No. k,
wherein the control unit is disposed to control at least one of the electric motor and of the gearshift device.

26. A casing suitable to accommodate a gearshift device for a mobility vehicle with a pedal crank comprising at least one wheel,
wherein said gearshift device comprises gears,
wherein said casing comprises a first compartment to accommodate at least the gears of the gearshift device, and
wherein a torque input to the gearshift device is via a shaft of the pedal crank and said casing comprises an air vent for venting the gears of the gearshift device.

27. A mobility vehicle comprising a drivetrain according to claim 16.

28. A method for controlling a mobility vehicle comprising a device comprising an electric motor disposed to provide all or a portion of propulsion of said device and a gearshift device having a plurality of k gear ratios between a first gear ratio referred to as gear ratio no. 1 and an upper gear ratio referred to as gear ratio No. k, each of the k gear ratios having a ratio, said gearshift device comprising a gearshift actuator disposed to engage a selected gear ratio having a ratio, said method comprising
allowing control of at least one of the electric motor and of the gearshift device.

29. The method according to claim 28, wherein the electric motor is connected to at least one output sprocket of the gearshift device.

30. The method according to claim 28, further comprising at least a step of increasing a torque of the electric motor in response to a signal corresponding to a request to change the gear ratio.

31. The drivetrain according to claim 21, wherein the gearshift device has between 5 and 9 gear ratios.

32. The drivetrain according to claim 24, wherein the reduction gear ratio jump between two consecutive gear ratios of the gearshift device is comprised between 15% and 40%.

33. A mobility vehicle comprising a control device according to claim 25.

34. A mobility vehicle comprising a casing according to claim 26.
